(19) United States
(12) Patent Application Publication
(10) Pub. No.: US 2017/0111301 A1
(43) Pub. Date: Apr. 20, 2017

(54) CLIENT SIDE QUEUE SHARDING

(71) Applicant: Vivint, Inc, Provo, UT (US)

(72) Inventor: Jared Robinson, Lehi, UT (US)

(21) Appl. No.: 14/885,720

(22) Filed: Oct. 16, 2015

(51) Int. Cl. H04L 12/58; H04L 29/06; H04L 29/08

(52) U.S. Cl. CPC H04L 51/14; H04L 67/10; H04L 67/42

(57) ABSTRACT

Methods and systems for routing messages are described. In one embodiment, the method includes generating a plurality of message exchanges of a message broker, generating a plurality of message queues of the message broker, and generating a first queue shard of a plurality of queue shards. In some embodiments, generating a first queue shard includes binding a first message exchange from the plurality of message exchanges with a first message queue from the plurality of message queues. In some embodiments, the method includes dedicating a first message server to the first queue shard. In some cases, the first message server includes a shared-nothing architecture.

### BACKGROUND

The present disclosure relates to security and/or automation systems, and more particularly to client side message queueing.

Security and automation systems are widely deployed to provide various types of communication and functional features such as monitoring, communication, notification, and/or others. These systems may be capable of supporting communication with a user through a communication connection or a system management action.

A conventional messaging system may distribute messages among a cluster of messaging servers. The cluster of messaging servers may be configured to process messages up to a certain number of message producers and/or message throughput. If the number of message producers increases, the messaging system's ability to process the increase in messages being produced diminishes. To handle the increase in messages, the cluster may be reconfigured. As the cluster is reconfigured, the messaging system is unable to process any messages.

### SUMMARY

The disclosure herein includes methods and systems for routing messages efficiently. The present systems and methods relate to improving the operations of messaging systems. In some embodiments, the present systems and methods include improving message systems via client side queue sharding.

A method for routing messages is described. In one embodiment, the method may include generating a plurality of message exchanges of a message broker, generating a plurality of message queues of the message broker, and generating a first queue shard of a plurality of queue shards. In some embodiments, generating a first queue shard may include binding a first message exchange from the plurality of message exchanges with a first message queue from the plurality of message queues. In some embodiments, the method may include dedicating a first message server to the first queue shard. In some cases, the first message server includes a shared-nothing architecture.

In some embodiments, the method may include identifying a plurality of messages from a plurality of message producers and distributing the received messages across the plurality of queue shards. In some cases, the method may include assigning a first message from the plurality of messages to the first queue shard and sending the first message to the first queue shard.

In some embodiments, the method may include identifying a no response from the first queue shard after sending the first message to the first queue shard. The no response may indicate the first queue shard is unavailable. In some embodiments, the method may include generating a second queue shard. Generating the second queue shard may include binding a second message exchange from the plurality of message exchanges with a second message queue from the plurality of message queues. In some embodiments, the method may include dedicating a second message server to the second queue shard. In some cases, the second message server may include a shared-nothing architecture. In some embodiments, the method may include sending the first message to the second queue shard after receiving the no response from the first queue shard. In some embodiments, the method may include waiting a predetermined amount of time after receiving the no response from the first queue shard and sending a test message such as a transport layer communication to the first queue shard after the predetermined amount of time lapses. In some embodiments, the method may include sending to the first queue shard a message subsequent to the first message upon receiving a response to transport layer communication.

An apparatus for client side queue sharding is also described. In one embodiment, the apparatus may include a processor, memory in electronic communication with the processor, and instructions stored in the memory, the instructions being executable by the processor to perform the steps of generating a plurality of message exchanges of a message broker, generating a plurality of message queues of the message broker, generating a first queue shard of a plurality of queue shards, binding a first message exchange from the plurality of message exchanges with a first message queue from the plurality of message queues, and dedicating a first message server to the first queue shard. In some cases, the first message server includes a shared-nothing architecture.

A non-transitory computer-readable medium is also described. The non-transitory computer readable medium may store computer-executable code, the code being executable by a processor to perform the steps of generating a plurality of message exchanges of a message broker, generating a plurality of message queues of the message broker, generating a first queue shard of a plurality of queue shards, binding a first message exchange from the plurality of message exchanges with a first message queue from the plurality of message queues, and dedicating a first message server to the first queue shard. In some cases, the first message server includes a shared-nothing architecture.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein—including their organization and method of operation—together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components—including those having a dash and a second reference label—apply to other similar components. If only the first reference label is used in the specification, the description is applicable to any one of the similar components having the same first reference label irrespective of the second reference label.

FIG. 1 shows a block diagram relating to a messaging system, in accordance with various aspects of this disclosure;

FIG. 2 shows a block diagram of a device relating to a messaging system, in accordance with various aspects of this disclosure;

FIG. 3 shows a block diagram of a device relating to a messaging system, in accordance with various aspects of this disclosure;

FIG. 4 shows an apparatus relating to a messaging system, in accordance with various aspects of this disclosure;

FIG. 5 shows a block diagram relating to a messaging system, in accordance with various aspects of this disclosure;

FIG. 6 is a flow chart illustrating an example of a method relating to a messaging system, in accordance with various aspects of this disclosure; and

FIG. 7 is a flow chart illustrating an example of a method relating to a messaging system, in accordance with various aspects of this disclosure.

### DETAILED DESCRIPTION

A messaging system may include one or more message producers generating multiple messages, one or more message queues, a message exchange to route the multiple messages to the one or more messages queues, and one or more message consumers to receive and process the multiple messages. In some cases, the messaging system may be referred to as a message broker. The messaging system may process several thousand messages/second at peak times. The messages may be produced by several thousand message producers. For example, a security monitoring service may monitor messages being generated from hundreds of thousands of security panels installed in homes, businesses, government offices, schools, etc.

In some embodiments, the messaging system may include any combination of hardware (e.g., processor, memory, storage, etc.), firmware, and/or software for exchanging messages between creators of messages and receivers of messages. For example, the messaging system may include one or more messaging servers. The messaging system may include an intermediary program module to translate a message from a first formal messaging protocol of a message sender to the same or different formal messaging protocol of a message receiver. The messaging system may include elements of a telecommunication network (e.g., transmission control protocol (TCP), etc.) that includes one or more programs (i.e., software applications) to communicate by exchanging formally-defined messages. The messaging system may include an architectural pattern for message validation, message transformation and message routing. In some cases, the messaging system may mediate communication amongst applications, minimizing the mutual awareness that applications would otherwise need to have of each other in order to be able to exchange messages, effectively implementing a decoupling between the sending application and the receiving application. In one embodiment, the messaging system may receive an incoming message from an application and perform one or more actions on the message. The messaging system may route messages to one or more destinations, transform messages to an alternative representation and/or format, perform message aggregation, decompose messages into multiple messages by sending messages to their indicated destination and recomposing one or more responses into one message to return to the user, interact with an external repository to augment a message or store it, invoke web services to retrieve data, respond to events or errors, provide content and topic-based message routing using the publish—subscribe pattern, etc.

In conventional messaging systems, message queues may be configured to distribute messages among a cluster of servers. As message producers are increased (e.g., new security panel installations), the load on the messaging system may increase exponentially. As one example, the maximum throughput of a single queue may be between 9 and 10 thousand messages per second. Thus, as the number of message producers increase, the cluster of servers may need to be upgraded to maintain an equivalent quality of service. Updating the cluster of servers, however, may include taking the entire messaging system offline as the cluster is reconfigured, resulting in a complete disruption of message flow.

In the present systems and methods, one exchange may be bound to one message queue to generate a queue shard. Thus, in one embodiment, each message queue in a messaging system may be bound exclusively to a message exchange to create independent queue shards. Each queue shard may be exclusively associated with its own messaging server. Accordingly, the one or more message producers may distribute their messages across the independent queue shards with several advantages. For example, a message producer may receive an exception when the message producer attempts to publish to a queue shard that is unavailable (e.g., the queue shard is deleted, the messaging server bound to the queue shard fails, the messaging server is taken offline for maintenance, etc.). When a message producer receives the exception, the message producer may simply choose another available queue shard to send its message. Accordingly, unlike conventional messaging systems, loss of the message is avoided and the message is sent with minimal delay. In some cases, the message producer may attempt to reestablish communication with the offline queue shard after waiting a predetermined amount of time.

In one embodiment, the messaging server bound to a queue shard may include a shared-nothing architecture. Unlike conventional messaging systems, clustering one or more of the messaging servers of the present systems and methods may be prevented. Accordingly, each queue shard may operate independent of each other queue shard.

In one embodiment, a message queue of a queue shard may be drained to allow maintenance on the queue shard and/or the associated messaging server. The messages in the affected message queue may be drained and transported to the messaging queues of one or more other queue shards. As one example, a message system may include four queue shards spread across four shared-nothing messaging nodes with 20 threads sharing a single message producer (4 TCP connections, 20 channels). In one instance, the messaging system may publish messages at a rate of 32,840 messages/second and 86 mbps. Increasing the number of queue shards in the messaging system to eight queue shards, still on four servers and 20 threads, the messaging system may publish messages at a rate of 41,370 messages/s and 133 mbps. Accordingly, the messaging system may be scaled to accommodate nearly any possible messaging scenario by simply increasing the number of queue shards in the system.

The present systems and methods provide several advantages over the conventional messaging system, including: (1) producers and consumers talk directly to a messaging server, resulting in reduced network traffic passing between nodes; (2) unlike conventional messaging systems, the present systems and methods require no load balancer for fail-over because clients handle fail-over automatically; (3) no need to configure a messaging cluster because each messaging server includes a shared-nothing architecture; (4) shared-nothing messaging servers may be removed without message loss and without affecting message flow because each messaging server operates independently; and (5) each messaging server may be updated without affecting any other messaging server.

In some embodiments, a message producer may connect to a queue shard at random. For example, out of four queue shards, a message producer may generate a random number between 1 and 4, and may select the queue shard based on the random number generated. Additionally, or alternatively, a message producer may be associated with a single queue shard and so may send its messages to its associated queue shard. In some embodiments, a message producer may select from among multiple queue shards based on a sequence. For example, a message producer may send a first message to a first queue shard, a second message to a second queue shard, etc. In some cases, a message producer may connect to a queue shard based on geography. For example, a message producer may send messages to the queue shard that is geographically closest to the message producer. In some cases, a message producer may determine a response time or latency associated with each available queue shard and may send messages based on the queue shard with the fastest response time or lowest latency. In some embodiments, a message producer may query available queue shards for a current workload or operating workload capacity (e.g., currently operating at 50% message processing capacity). In some cases, a queue shard may communicate on a regular basis a current operating workload to message producers. In some embodiments, the message producer may connect to the queue shard with the fewest message producers connected to it. In one configuration, the message producer may include a management representational state transfer (REST) application program interface (API) to enable the message producer to determine which queue shard has the fewest message producers connected to it. In some cases, a message producer may include a whitelist of queue shards to select from, enabling the message producer to connect with only those queue shards on the whitelist.

Likewise, a message consumer may connect to a queue shard at random, may be associated with a single queue shard and so may consume its messages from its associated queue shard, may select among multiple queue shards based on a sequence (e.g., consume a message from a first queue shard, next consume a message from a second queue shard, etc.), may connect to a queue shard based on geography, may determine a response time or latency associated with each available queue shard and may consume messages based on the queue shard with the fastest response time or lowest latency, and/or may query available queue shards for a current workload or operating workload capacity. In some cases, a queue shard may communicate on a regular basis a current operating workload to message consumers. In some embodiments, the message consumer may connect to the queue shard with the fewest message consumers connected to it. In one configuration, the message consumer may include a REST API to enable the message consumer to determine which queue shard has the fewest message consumers connected to it. In some cases, a message consumer may include a whitelist of queue shards to select from, enabling the message consumer to connect with only those queue shards on the whitelist.

The following description provides examples and is not limiting of the scope, applicability, and/or examples set forth in the claims. Changes may be made in the function and/or arrangement of elements discussed without departing from the scope of the disclosure. Various examples may omit, substitute, and/or add various procedures and/or components as appropriate. For instance, the methods described may be performed in an order different from that described, and/or various steps may be added, omitted, and/or combined. Also, features described with respect to some examples may be combined in other examples.

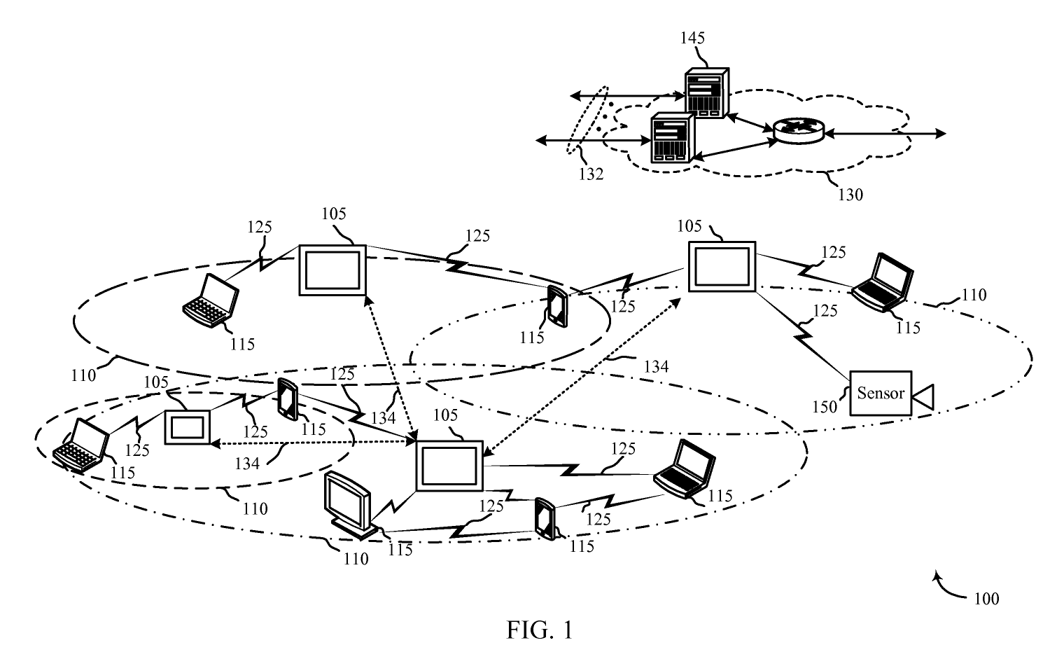

FIG. 1 illustrates an example of a communications system 100 in accordance with various aspects of the disclosure. The communications system 100 may include control panels 105, devices 115, a network 130, and/or sensors 150. The network 130 may provide user authentication, encryption, access authorization, tracking, Internet Protocol (IP) connectivity, transmission control protocol (TCP) connectivity, and other access, calculation, modification, and/or functions. The control panels 105 may interface with the network 130 through a first set of wired and/or wireless communication links 132 to communicate with one or more remote servers 145. In some embodiments, messages may be communicated between the illustrated devices and/components of the communications system 100, including messages communicated between control panels 105, devices 115, network 130, sensors 150, the one or more remote servers 145, and so forth.

The control panels 105 may perform communication configuration, adjustment, and/or scheduling for communication with the devices 115, or may operate under the control of a controller. In various examples, the control panels 105 may communicate—either directly or indirectly (e.g., through network 130)—with each other over a second set of wired and/or wireless communication links 134. Control panels 105 may communicate with a back end server (such as the remote servers 145)—directly and/or indirectly—using the first set of one or more communication links 132.

The control panels 105 may wirelessly communicate with the devices 115 via one or more antennas. Each of the control panels 105 may provide communication coverage for a respective geographic coverage area 110. In some examples, control panels 105 may be referred to as a control device, a base transceiver station, a radio base station, an access point, a radio transceiver, or some other suitable terminology. The geographic coverage area 110 for a control panel 105 may be divided into sectors making up only a portion of the coverage area. The communications system 100 may include control panels 105 of different types. There may be overlapping geographic coverage areas 110 for one or more different parameters, including different technologies, features, subscriber preferences, hardware, software, technology, and/or methods. For example, each control panel 105 may be related to one or more discrete structures (e.g., a home, a business) and each of the one more discrete structures may be related to one or more discrete areas. In other examples, multiple control panels 105 may be related to the same one or more discrete structures (e.g., multiple control panels relating to a home and/or a business complex).

The devices 115 may be dispersed throughout the communications system 100 and each device 115 may be stationary and/or mobile. A device 115 may include a cellular phone, a personal digital assistant (PDA), a wireless modem, a wireless communication device, a handheld device, a tablet computer, a laptop computer, a cordless phone, a wireless local loop (WLL) station, a display device (e.g., TVs, computer monitors, etc.), a printer, a camera, and/or the like. A device 115 may also include or be referred to by those skilled in the art as a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

The control panels 105 may wirelessly communicate with the sensors 150 via one or more antennas. The sensors 150 may be dispersed throughout the communications system 100 and each sensor 150 may be stationary and/or mobile. A sensor 150 may include and/or be one or more sensors that sense: proximity, motion, temperatures, humidity, sound level, smoke, structural features (e.g., glass breaking, window position, door position), time, light geo-location data of a user and/or a device, distance, biometrics, weight, speed, height, size, preferences, light, darkness, weather, time, system performance, and/or other inputs that relate to a messaging system. A device 115 and/or a sensor 150 may be able to communicate through one or more wired and/or wireless connections with various components such as control panels, base stations, and/or network equipment (e.g., servers, wireless communication points, etc.) and/or the like.

The communication links 125 shown in communications system 100 may include uplink (UL) transmissions from a device 115 to a control panel 105, and/or downlink (DL) transmissions, from a control panel 105 to a device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies. Each modulated signal may be sent on a different sub-carrier and may carry control information (e.g., reference signals, control channels, etc.), overhead information, user data, etc. The communication links 125 may transmit bidirectional communications and/or unidirectional communications. Communication links 125 may include one or more connections, including but not limited to, 345 MHz, Wi-Fi, BLUETOOTH®, BLUETOOTH® Low Energy, cellular, Z-WAVE®, 802.11, peer-to-peer, LAN, WLAN, Ethernet, fire wire, fiber optic, and/or other connection types related to security and/or automation systems.

In some embodiments, of communications system 100, control panels 105 and/or devices 115 may include one or more antennas for employing antenna diversity schemes to improve communication quality and reliability between control panels 105 and devices 115. Additionally or alternatively, control panels 105 and/or devices 115 may employ multiple-input, multiple-output (MIMO) techniques that may take advantage of multi-path, mesh-type environments to transmit multiple spatial layers carrying the same or different coded data.

While the devices 115 may communicate with each other through the control panel 105 using communication links 125, each device 115 may also communicate directly with one or more other devices via one or more direct communication links 134. Two or more devices 115 may communicate via a direct communication link 134 when both devices 115 are in the geographic coverage area 110 or when one or neither devices 115 is within the geographic coverage area 110. Examples of direct communication links 134 may include Wi-Fi Direct, BLUETOOTH®, wired, and/or, and other P2P group connections. The devices 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within communications system 100.

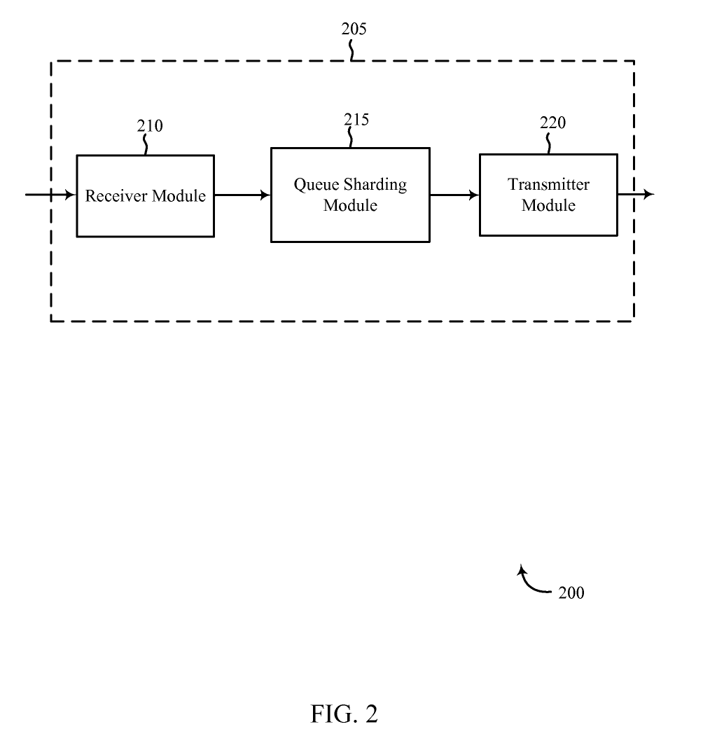

FIG. 2 shows a block diagram 200 of a device 205 for use in electronic communication, in accordance with various aspects of this disclosure. The device 205 may be an example of one or more aspects of control panels 105, devices 115, sensors 150, and/or the one or more remote servers 145 of FIG. 1. The device 205 may include a receiver module 210, a queue sharding module 215, and/or a transmitter module 220. The device 205 may also be or include a processor. Each of these modules may be in communication with each other—directly and/or indirectly.

The components of the device 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

The receiver module 210 may receive information such as packets, user data, and/or control information associated with various information channels (e.g., control channels, data channels, etc.). In one embodiment, the receiver module 210 may be configured to receive messages generated by a control panel and/or sensors connected to a control panel. The messages and/or information within the messages may be passed on to the queue sharding module 215, and to other components of the device 205. The queue sharding module 215 may process the messages received by receiver module 210 and forward the processed messages to one or more message exchanges where the messages may be queued for consumption by one or more message consumers.

The transmitter module 220 may transmit the one or more signals received from other components of the device 205. The transmitter module 220 may transmit messages processed by queue sharding module 215. In some examples, the transmitter module 220 may be collocated with the receiver module 210 in a transceiver module.

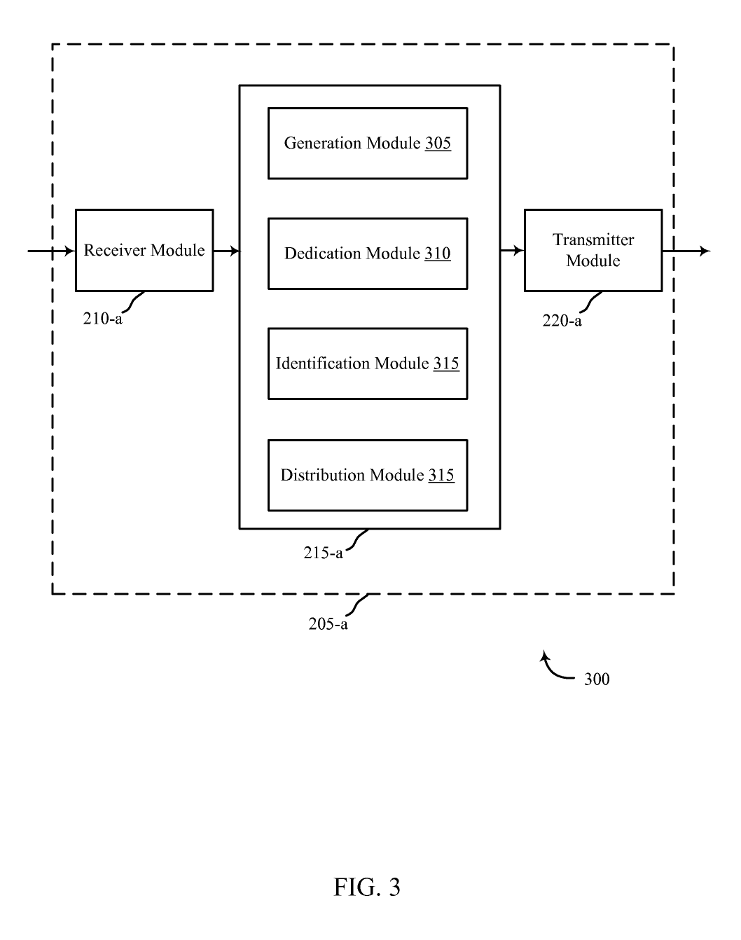

FIG. 3 shows a block diagram 300 of a device 205-a for use in wireless communication, in accordance with various examples. The device 205-a may be an example of one or more aspects of control panels 105, devices 115, sensors 150, and/or the one or more remote servers 145 of FIG. 1. The device 205-a may include a receiver module 210-a, a queue sharding module 215-a, and/or a transmitter module 220-a, which may be examples of the corresponding modules of device 205. The device 205-a may also include a processor, memory, and/or storage, etc. Each of these components may be in communication with each other. The queue sharding module 215-a may include generation module 305, dedication module 310, identification module 315, and distribution module 320. The receiver module 210-a and the transmitter module 220-a may perform the functions of the receiver module 210 and the transmitter module 220, of FIG. 2, respectively.

The components of the device 205-a may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented—in whole or in part—with instructions embodied in memory formatted to be executed by one or more general and/or application-specific processors.

In one embodiment, queue sharding module 215-a operates in conjunction with and/or includes one or more processors, memory, storage devices, software, and/or firmware. In some cases, queue sharding module 215-a operates in conjunction with and/or includes a message broker system. In some cases, queue sharding module 215-a enables a messaging system to distribute messages using client-side queue sharding. In one embodiment, the queue sharding module 215-a binds one or more message exchanges with one or more message queues, one exchange per queue. In some embodiments, client-side queue sharding enables message producers to spread their messages over multiple exchanges, enables a single message producer to select a second exchange when a first exchange does not respond, enables a message exchange to be taken down without affecting the rate of message flow, and so forth.

In one embodiment, the generation module 305 may generate one or more message exchanges. In some cases, the generation module 305 may generate multiple message exchanges. In some embodiments, the one or more message exchanges may be generated by the generation module 305 in relation to a message broker. In some configurations, generation module 305 may generate one or more message queues in relation to the message broker. In some cases, generation module 305 may generate one or more queue shards. In some embodiments, generating a queue shard may include binding a message exchange from the one or more message exchanges with a message queue from the one or more message queues. Thus, in some embodiments, a message may be received into a first queue by sending the message to a first message exchange that is bound to the first queue. Likewise, a message may be received into a second queue by sending the message to a second message exchange that is bound to the second queue.

In one embodiment, the dedication module 310 may dedicate a first message server to the first queue shard. Thus, in some embodiments, a first message queue may be bound to a first message exchange by the generation module 305 to generate a first queue shard, and the first queue shard may be bound to a first message server by the dedication module 310. In some embodiments, the first message queue may be exclusively bound to the first message exchange to generate a first queue shard, and the first queue shard may be exclusively bound to a first message server. In some cases, the first message server may include a shared-nothing architecture. A shared nothing architecture may include a distributed computing architecture in which each node is independent and self-sufficient, resulting in no single point of contention across the system. In some cases, a shared nothing device does not share resources such as software applications, firmware, processor, memory, disk storage, etc. In some cases, a shared nothing system may include two separate devices that do not share resources. Additionally, or alternatively, a shared nothing system may include a device that allocates a first exclusive portion of processor, memory, and/or storage from one device to a first process and allocates a second exclusive portion of processor, memory, and/or storage from the same one device to a second process. For example, a server that includes multiple processors, multiple banks of memory (e.g., multiple chips, multiple dual in-line memory modules (DIMMS), etc.), and/or multiple storage devices (e.g., multiple platters, multiple sectors of a drive, multiple hard disk drives, multiple solid state drives, etc.) may allocate the resources exclusively among several processes. For instances, a first processor from the multiple processors may be allocated exclusively to a first process and a second processor from the multiple processors may be allocated exclusively to a second process, and so forth.

In one embodiment, identification module 315 may identify a plurality of messages from a plurality of message producers. In some embodiments, distribution module 320 may distribute the received messages across the plurality of queue shards. In one embodiment, distribution module 320 may assign a first message from the plurality of messages to a first queue shard and send the first message to the first queue shard. Thus, the exchange of the first queue shard may store the first message in the queue of the first queue shard until the first message is retrieved and consumed/processed by a message consumer.

In one embodiment, messages may be generated by multiple message producers that include at least a first message producer, a second message producer, etc. In some cases, the distribution module 320 may assign any message from the first message producer to the first queue shard, any message from the second message producer to the second queue shard, and so forth. Additionally, or alternatively, the distribution module 320 may assign messages in a round robin manner in the order messages are generated by a message producer and/or in the order messages are received by the distribution module 320. Using an example of four available queue shards, and in conjunction with the distribution module 320, a first message from a first message producer may be assigned to a first queue shard, a next message from a second message producer may be assigned to a second queue shard, a next message from a third message producer may be assigned to a third queue shard, another message from the first message producer may be assigned to a fourth queue shard, and having reached the fourth queue shard the next message being from a fourth message producer may be assigned to the first queue shard, and so forth. Thus, in some embodiments, the distribution module 320 may assign messages in a round-robin fashion as they are generated/received according to a predetermined sequence of queue shards, starting over at a first queue shard in the sequence after assigning a message to the last queue shard in the sequence.

In one embodiment, identification module 315 may identify a no response from the first queue shard after sending a message to the first queue shard. The no response may indicate the first queue shard is unavailable. The first queue shard may be unavailable due to the first queue shard being taken offline by an administrator and/or the first queue shard having a failure.

In one embodiment, generation module 305 may generate a second queue shard. Generating the second queue shard may include binding a second message exchange with a second message queue. In some embodiments, dedication module 310 may dedicate a second message server to the second queue shard. Like the first message server, the second message server may include a shared-nothing architecture in some embodiments. After receiving the no response from the first queue shard, distribution module 320 may send the first message to the second queue shard. Thus, even when a queue shard is unavailable, the queue sharding module 215-a may continue the flow of messages without message loss and with relatively imperceptible impact on performance compared to conventional messaging systems.

After receiving the no response from the first queue shard, distribution module 320 may wait a predetermined amount of time before attempting to send another message to the first queue shard. In some cases, distribution module 320 may send a transport layer communication to the first queue shard after the predetermined amount of time lapses. The distribution module 320 may send a transport layer communication to reestablish transport layer communication protocols with the first queue shard. In one embodiment, the transport layer communication may include one or more transport layer packets. The packets may include control information, protocol information, and/or data. The transport layer protocols associated with the transport layer communication may include the transmission control protocol (TCP), the user datagram protocol (UDP), the datagram congestion control protocol (DCCP), the stream control transmission protocol (SCTP), and/or other similar transport layer protocols. The transport layer communication may include a protocol based on the TCP/IP model and/or the open system interconnection (OSI) model of networking.

Upon receiving no response, distribution module 320 may again wait the predetermined amount of time before attempting to send another transport layer communication to the first queue shard. Upon receiving a response to the transport layer communication, distribution module 320 may send a message to the first queue shard. In some embodiments, the message sent after receiving a response to the transport layer communication may be the same message the distribution module 320 attempted to send to the first queue shard when the no response was identified by the identification module 315. Alternatively, as described above, the first message may be rerouted by the distribution module 320 from the first queue shard to the second queue shard, and after receiving a response to the transport layer communication, the distribution module 320 may send a different, subsequent message to the first queue shard.

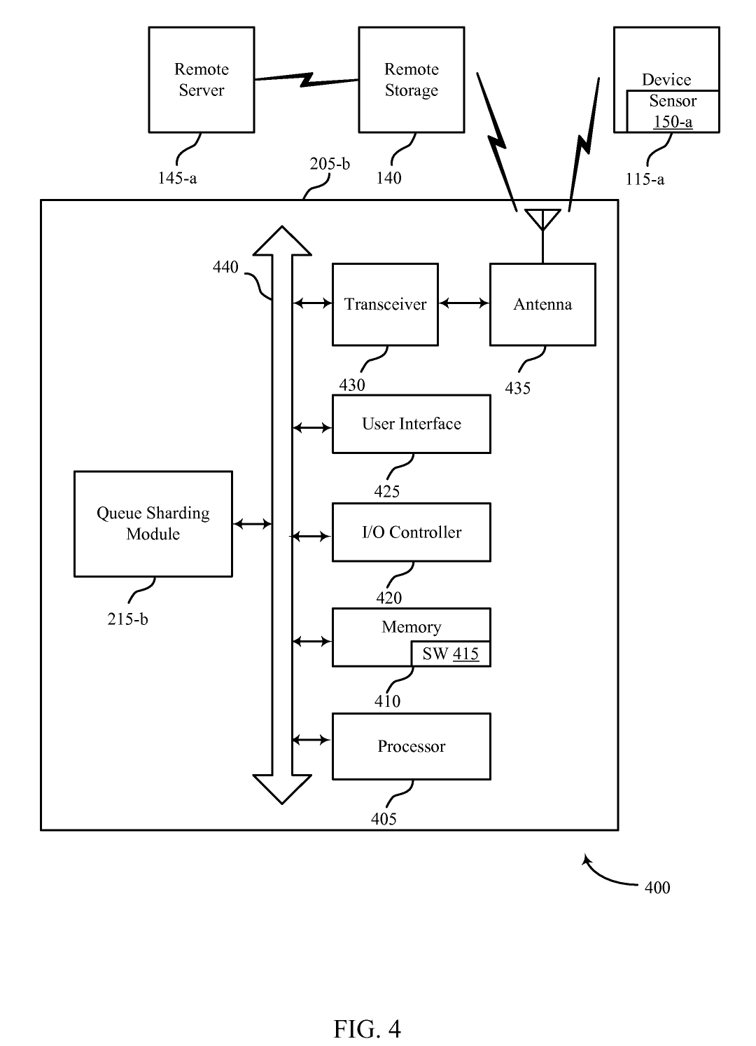

FIG. 4 shows a system 400 for use in messaging systems, in accordance with various examples. System 400 may include apparatus 205-b, which may be an example of the control panels 105, devices 115, sensors 150, and/or the one or more remote servers 145 of FIG. 1. Apparatus 205-b may also be an example of one or more aspects of control panels 205 and/or 205-a of FIGS. 2 and 3.

Apparatus 205-b may also include components for bi-directional voice and data communications including components for transmitting communications and components for receiving communications. For example, apparatus 205-b may communicate bi-directionally with one or more of device 115-a, one or more sensors 150-a, remote storage 140, and/or remote server 145-a, which may be an example of the remote server of FIG. 1. This bi-directional communication may be direct (e.g., apparatus 205-b communicating directly with remote storage 140) or indirect (e.g., apparatus 205-b communicating indirectly with remote server 145-a through remote storage 140).

Apparatus 205-b may also include a processor module 405, and memory 410 (including software/firmware code (SW) 415), an input/output controller module 420, a user interface module 425, a transceiver module 430, and one or more antennas 435 each of which may communicate—directly or indirectly—with one another (e.g., via one or more buses 440). The transceiver module 430 may communicate bi-directionally—via the one or more antennas 435, wired links, and/or wireless links—with one or more networks or remote devices as described above. For example, the transceiver module 430 may communicate bi-directionally with one or more of device 115-a, remote storage 140, and/or remote server 145-a. The transceiver module 430 may include a modem to modulate the packets and provide the modulated packets to the one or more antennas 435 for transmission, and to demodulate packets received from the one or more antenna 435. While a control panel or a control device (e.g., 205-b) may include a single antenna 435, the control panel or the control device may also have multiple antennas 435 capable of concurrently transmitting or receiving multiple wired and/or wireless transmissions. In some embodiments, one element of apparatus 205-b (e.g., one or more antennas 435, transceiver module 430, etc.) may provide a direct connection to a remote server 145-a via a direct network link to the Internet via a POP (point of presence). In some embodiments, one element of apparatus 205-b (e.g., one or more antennas 435, transceiver module 430, etc.) may provide a connection using wireless techniques, including digital cellular telephone connection, Cellular Digital Packet Data (CDPD) connection, digital satellite data connection, and/or another connection.

The signals associated with system 400 may include wireless communication signals such as radio frequency, electromagnetics, local area network (LAN), wide area network (WAN), virtual private network (VPN), wireless network (using 802.11, for example), 345 MHz, Z-WAVE®, cellular network (using 3G and/or LTE, for example), and/or other signals. The one or more antennas 435 and/or transceiver module 430 may include or be related to, but are not limited to, WWAN (GSM, CDMA, and WCDMA), WLAN (including BLUETOOTH® and Wi-Fi), WMAN (WiMAX), antennas for mobile communications, antennas for Wireless Personal Area Network (WPAN) applications (including RFID and UWB). In some embodiments, each antenna 435 may receive signals or information specific and/or exclusive to itself. In other embodiments, each antenna 435 may receive signals or information not specific or exclusive to itself.

In some embodiments, one or more sensors 150-a (e.g., motion, proximity, smoke, light, glass break, door, window, carbon monoxide, and/or another sensor) may connect to some element of system 400 via a network using one or more wired and/or wireless connections.

In some embodiments, the user interface module 425 may include an audio device, such as an external speaker system, an external display device such as a display screen, and/or an input device (e.g., remote control device interfaced with the user interface module 425 directly and/or through I/O controller module 420).

One or more buses 440 may allow data communication between one or more elements of apparatus 205-b (e.g., processor module 405, memory 410, I/O controller module 420, user interface module 425, etc.).

The memory 410 may include random access memory (RAM), read only memory (ROM), flash RAM, and/or other types. The memory 410 may store computer-readable, computer-executable software/firmware code 415 including instructions that, when executed, cause the processor module 405 to perform various functions described in this disclosure (e.g., receive multiple messages and route the multiple messages among available queue shards, etc.). Alternatively, the software/firmware code 415 may not be directly executable by the processor module 405 but may cause a computer (e.g., when compiled and executed) to perform functions described herein. Alternatively, the computer-readable, computer-executable software/firmware code 415 may not be directly executable by the processor module 405 but may be configured to cause a computer (e.g., when compiled and executed) to perform functions described herein. The processor module 405 may include an intelligent hardware device, e.g., a central processing unit (CPU), a microcontroller, an application-specific integrated circuit (ASIC), etc.

In some embodiments, the memory 410 can contain, among other things, the Basic Input-Output system (BIOS) which may control basic hardware and/or software operation such as the interaction with peripheral components or devices. For example, the modules and/or components of FIG. 4 configured to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface (e.g., transceiver module 430, one or more antennas 435, etc.).

Many other devices and/or subsystems may be connected to one or may be included as one or more elements of system 400 (e.g., entertainment system, computing device, remote cameras, wireless key fob, wall mounted user interface device, cell radio module, battery, alarm siren, door lock, lighting system, thermostat, home appliance monitor, utility equipment monitor, and so on). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be iOS®, ANDROID®, MS-DOS®, MS-WINDOWS®, OS/2®, UNIX®, LINUX®, or another known operating system.

The transceiver module 430 may include a modem configured to modulate the packets and provide the modulated packets to the antennas 435 for transmission and/or to demodulate packets received from the antennas 435. While the control panel or control device (e.g., 205-b) may include a single antenna 435, the control panel or control device (e.g., 205-b) may have multiple antennas 435 capable of concurrently transmitting and/or receiving multiple wireless transmissions. The apparatus 205-b may include a queue sharding module 215-b, which may perform the functions described above for the queue sharding modules 215 of device 205 of FIGS. 2 and 3.

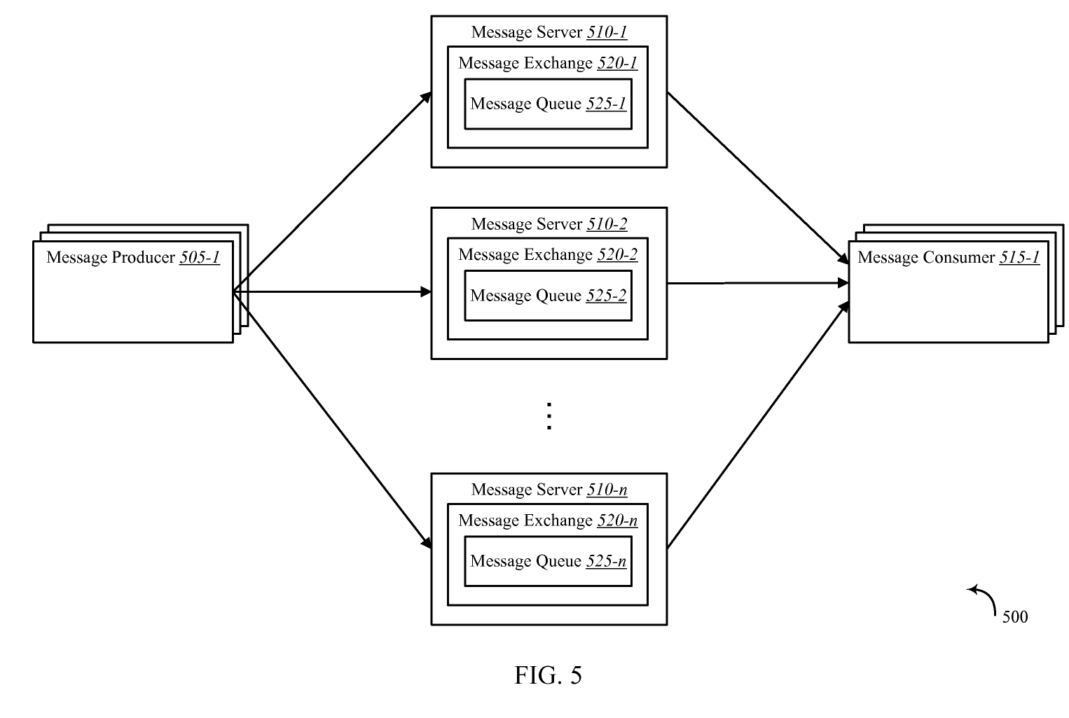

FIG. 5 shows a block diagram of a messaging system 500, in accordance with various aspects of this disclosure. The messaging system 500 may include one or more message producers 505, one or more message servers 510, and one or more message consumers 515. The message producers 505, message servers 510, and/or message consumers 515 may be examples of one or more aspects of control panels 105, devices 115, sensors 150, and/or the one or more remote servers 145 of FIG. 1. In some embodiments, the messaging system 500 may include one or more networks. For example, one or more networks may be located between the one or more message producers 505 and the one or more message servers 510. Additionally, or alternatively, one or more networks may exist between the one or more message servers 510 and the one or more message consumers 515. Accordingly, the one or more message producers 505 may generate several messages and distribute these messages among the one or more messages servers 510. Likewise, the one or more message consumers 515 may consume the messages queued in the one or more message queues 525.

As depicted, a first message server 510-1 may include a first message exchange 520-1, a second message server 510-2 may include a second message exchange 520-2, and an nth message server 510-n may include an nth message exchange 520-n. Also illustrated, the first message exchange 520-1 may include a first message queue 525-1, the second message exchange 520-2 may include a second message queue 525-2, the nth message exchange 520-2 may include an nth message queue 525-n, and so forth. In one embodiment, the first message queue 525-1 may be bound to the first message exchange 520-1, allowing only the first message exchange 520-1 to utilize the first message queue 525-1. Binding the first message exchange 520-1 with the first message queue 525-1 may create a first queue shard. Likewise, the second message queue 525-2 may be bound to the second message exchange 520-2, and so forth. In some cases, the first message server 510-1 may be dedicated or bound to the first queue shard. Similarly, in some embodiments, the second message server 510-2 may be dedicated or bound to the second queue shard, and so forth. In some embodiments, the one or more message servers 510 may include a shared-nothing architecture.

In one embodiment, the one or more message producers 505 may generate multiple messages. The messages may be received by the one or more message servers 510. For example, a first message producer 505-1 may send a message to message server 510-1, a second message producer 505-2 may send a message to message server 510-2, and an nth message producer 505-n may send a message to message server 510-n. In some embodiments, the one or more message producers 505 may select from available message servers 510 and send messages to any one of the available message servers 510. For examples, a first message producer 505-1 may send one message to message server 510-2, another message to message server 510-1, and another message to message server 510-n, and so forth.

In one embodiment, the first message producer 505-1 may send a transport layer communication to the first message server 510-1. For example, the first message producer 505-1 may send one or more TCP packets to the first message server 510-1. If the first message producer 505-1 receives a response from message server 510-1, the first message producer 505-1 may send a message to the first message server 510-1 intended for the first message exchange 520-1. If the first message producer 505-1 does not receive a response from the message server 510-1 (e.g., the message server 510-1 is offline, etc.), the first message producer may send a transport layer communication to the second message server 510-2. If the second message server 510-2 sends a response to the first message producer 505-1, the first message producer 505-1 may send a message to the second message server 510-2. Accordingly, the messaging system 500 may enable multiple message producers to queue several messages for message consumers without message loss even if one or more message servers 510 go offline while one or more message servers 510 remain online.

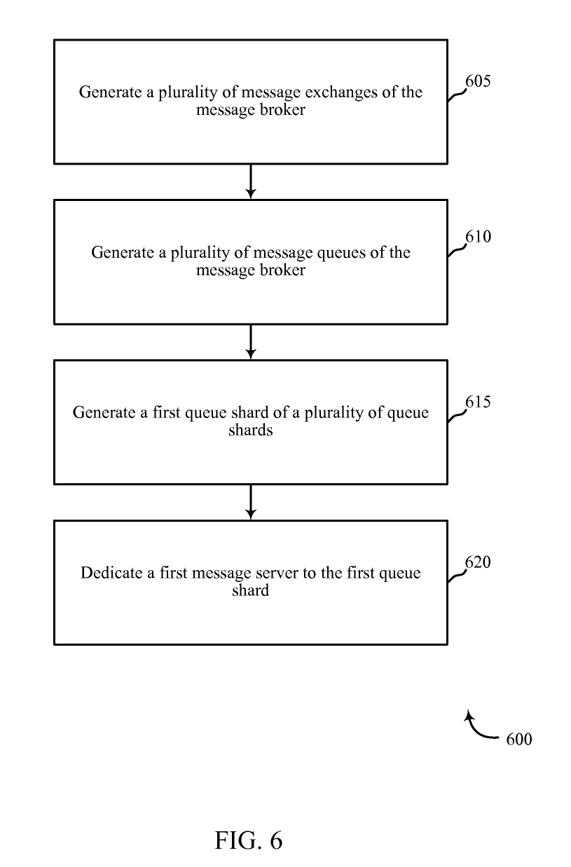

FIG. 6 is a flow chart illustrating an example of a method 600 for routing messages, in accordance with various aspects of the present disclosure. For clarity, the method 600 is described below with reference to aspects of one or more of the control panels 105, devices 115, sensors 150, and/or the one or more remote servers 145 of FIG. 1, and/or aspects of one or more of the queue sharding module 215 described with reference to FIGS. 2, 3, and/or 4. In some examples, a control panel, client device, backend server, and/or sensor may execute one or more sets of codes to perform the functions described below. Additionally or alternatively, the control panel, client device, backend server, and/or sensor may perform one or more of the functions described below using special-purpose hardware.

At block 605, the method 600 may include generating a plurality of message exchanges. At block 610, the method 600 may include generating a plurality of message queues of the message broker. At block 615, the method 600 may include generating a first queue shard of a plurality of queue shards. In some cases, generating the first queue shard may include binding a first message exchange from the plurality of message exchanges with a first message queue from the plurality of message queues. At block 620, the method 600 may include dedicating a first message server to the first queue shard. In some cases, the first message server may include a shared-nothing architecture.

Thus, the method 600 may provide for client side queue sharding relating to messaging systems. It should be noted that the method 600 is just one implementation and that the operations of the method 600 may be rearranged or otherwise modified such that other implementations are possible.

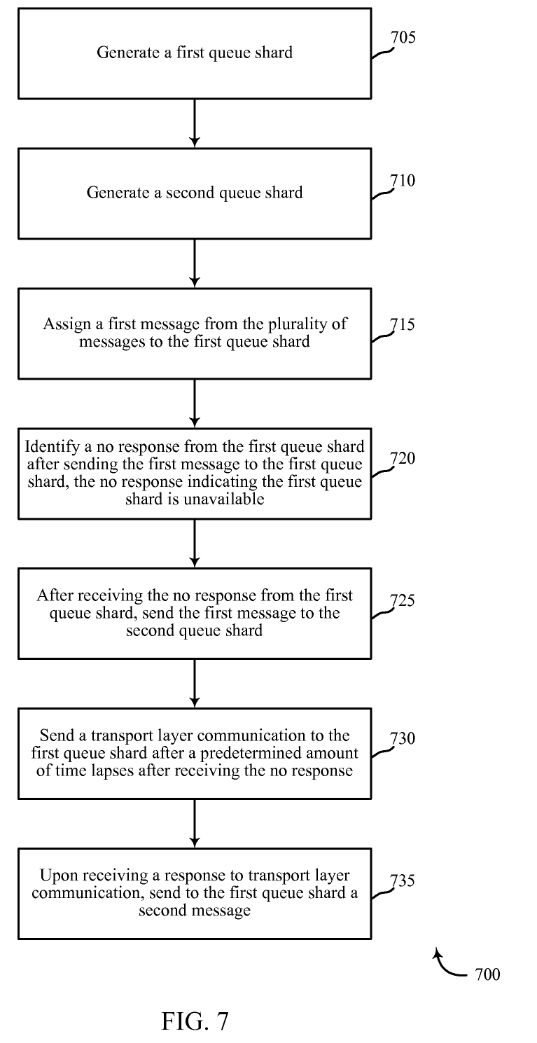

FIG. 7 is a flow chart illustrating an example of a method 700 for routing messages, in accordance with various aspects of the present disclosure. For clarity, the method 700 is described below with reference to aspects of one or more of the control panels 105, devices 115, sensors 150, and/or the one or more remote servers 145 of FIG. 1, and/or aspects of one or more of the queue sharding module 215 described with reference to FIGS. 2, 3, and/or 4. In some examples, a control panel, client device, backend server, and/or sensor may execute one or more sets of codes to perform the functions described below. Additionally or alternatively, the control panel, client device, backend server, and/or sensor may perform one or more of the functions described below using special-purpose hardware.

At block 705, the method 700 may include generating a first queue shard. At block 710, the method 700 may include generating a second queue shard. In some cases, generating a queue shard may include binding a message exchange with a message queue. At block 715, the method 700 may include assigning a first message from the plurality of messages to the first queue shard. In some cases, the method 700 may include sending the first message to the first queue shard. At block 720, the method 700 may include identifying a no response from the first queue shard after sending the first message to the first queue shard. The no response may indicate the first queue shard is unavailable. At block 725, the method 700 may include sending the first message to the second queue shard after receiving the no response from the first queue shard. At block 730, the method 700 may include sending a transport layer communication to the first queue shard after a predetermined amount of time lapses after receiving the no response. At block 735, the method 700 may include sending to the first queue shard a second message upon receiving a response to transport layer communication.

Thus, the method 700 may provide for client side queue sharding relating to messaging systems. It should be noted that the method 700 is just one implementation and that the operations of the method 700 may be rearranged or otherwise modified such that other implementations are possible.

In some examples, aspects from two or more of the methods 600 and/or 700 may be combined and/or separated. It should be noted that the methods 600 and 700 are just example implementations, and that the operations of the methods 600 and/or 700 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, e.g., a combination of a DSP and a microprocessor, multiple microprocessors, one or more microprocessors in conjunction with a DSP core, and/or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to automation system applications. In some embodiments, the concepts, the technical descriptions, the features, the methods, the ideas, and/or the descriptions may specifically apply to security and/or automation system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A method for routing messages, comprising:
generating, by a processor associated with a message broker, a plurality of message exchanges of the message broker;
generating, by the processor, a plurality of message queues of the message broker;
generating, by the processor, a first queue shard, generating the first queue shard comprising binding a first message exchange from the plurality of message exchanges with a first message queue from the plurality of message queues; and
dedicating, by the processor, a first message server to the first queue shard, wherein the first message server comprises a shared-nothing architecture.

2. The method of claim 1, comprising:
identifying a plurality of messages from a plurality of message producers; and
distributing the received messages across the plurality of queue shards.

3. The method of claim 2, comprising:
assigning a first message from the plurality of messages to the first queue shard.

4. The method of claim 3, comprising:
sending the first message to the first queue shard.

5. The method of claim 4, comprising:
identifying a no response from the first queue shard after sending the first message to the first queue shard, the no response indicating the first queue shard is unavailable.

6. The method of claim 5, comprising:
generating a second queue shard, generating the second queue shard comprising binding a second message exchange from the plurality of message exchanges with a second message queue from the plurality of message queues.

7. The method of claim 6, comprising:
dedicating a second message server to the second queue shard, wherein the second message server comprises a shared-nothing architecture.

8. The method of claim 6, comprising:
after receiving the no response from the first queue shard, sending the first message to the second queue shard.

9. The method of claim 5, comprising:
after receiving the no response from the first queue shard, waiting a predetermined amount of time; and
sending a transport layer communication to the first queue shard after the predetermined amount of time lapses.

10. The method of claim 9, comprising:
upon receiving a response to the transport layer communication, sending a message subsequent to the first message to the first queue shard.

11. An apparatus for an automation system, comprising:
a processor;
memory in electronic communication with the processor; and
instructions stored in the memory, the instructions being executable by the processor to perform the steps of:
generating a plurality of message exchanges in relation to a message broker;
generating a plurality of message queues in relation to the message broker;
generating a first queue shard, generating the first queue shard comprising binding a first message exchange from the plurality of message exchanges with a first message queue from the plurality of message queues; and
dedicating a first message server to the first queue shard, wherein the first message server comprises a shared-nothing architecture

12. The apparatus of claim 11, the instructions being executable by the processor to perform the steps of:
identifying a plurality of messages from a plurality of message producers; and
distributing the received messages across the plurality of queue shards.

13. The apparatus of claim 12, the instructions being executable by the processor to perform the step of:
assigning a first message from the plurality of messages to the first queue shard.

14. The apparatus of claim 13, the instructions being executable by the processor to perform the step of:
sending the first message to the first queue shard.

15. The apparatus of claim 14, the instructions being executable by the processor to perform the step of:
identifying a no response from the first queue shard after sending the first message to the first queue shard, the no response indicating the first queue shard is unavailable.

16. The apparatus of claim 15, the instructions being executable by the processor to perform the step of:
generating a second queue shard, generating the second queue shard comprising binding a second message exchange from the plurality of message exchanges with a second message queue from the plurality of message queues.

17. The apparatus of claim 16, the instructions being executable by the processor to perform the step of:
dedicating a second message server to the second queue shard, wherein the second message server comprises a shared-nothing architecture.

18. The apparatus of claim 16, the instructions being executable by the processor to perform the step of:
after receiving the no response from the first queue shard, sending the first message to the second queue shard.

19. The apparatus of claim 15, the instructions being executable by the processor to perform the steps of:
after receiving the no response from the first queue shard, waiting a predetermined amount of time; and
sending a transport layer communication to the first queue shard after the predetermined amount of time lapses.

20. A non-transitory computer-readable medium storing computer-executable code for an automation system, the code executable by a processor to perform the steps of:
generating a plurality of message exchanges of a message broker;
generating a plurality of message queues of the message broker;
generating a first queue shard, generating the first queue shard comprising binding a first message exchange from the plurality of message exchanges with a first message queue from the plurality of message queues; and
dedicating a first message server to the first queue shard, wherein the first message server comprises a shared-nothing architecture.
